(19) United States
(12) Patent Application Publication
(10) Pub. No.: US 2009/0126133 A1
(43) Pub. Date: May 21, 2009

(54) Adhesive roll cleaner, and apparatus for and method of manufacturing the same

(76) Inventor: Tae-Hyoun RYU, Gyeongsangbuk-do (KR)

Correspondence Address: PARK LAW FIRM, 3255 WILSHIRE BLVD, SUITE 1110, LOS ANGELES, CA, 90010, US

(21) Appl. No.: 12/043,856

(22) Filed: Mar. 6, 2008

(30) Foreign Application Priority Data
Nov. 12, 2007 (KR) 10-2007-0114790

(51) Int. Cl. A47L 25/00; B32B 38/18; B32B 38/04

(52) U.S. Cl. 15/104.002; 156/459; 156/192

(57) ABSTRACT

Disclosed herein are an adhesive roll cleaner for cleaning beds or carpets, and apparatus for and method of manufacturing the adhesive roll cleaner. The adhesive roll cleaner can catch up hairs, fine dusts or the like, that cannot be sufficiently caught up by general cleaning tools, using an adhesive force of an adhesive tape, prevent that the adhesive tape is torn in a longitudinal direction when a soiled portion of the adhesive tape is separated from the adhesive tape, and allow the soiled portion of the adhesive tape to be easily separated from the adhesive tape without any damage of the adhesive tape even in a state where long hairs or vinyl segments adhere to the adhesive tape.

### BACKGROUND OF THE INVENTION

1. Field of the Invention

The present invention relates to an adhesive roll cleaner for cleaning beds or carpets, and apparatus for and method of manufacturing the adhesive roll cleaner. More particularly, the present invention relates to an adhesive roll cleaner, which can catch up hairs, fine dusts or the like, that cannot be sufficiently caught up by general cleaning tools, using an adhesive force of an adhesive tape, and which can prevent the adhesive tape from being torn in a longitudinal direction when a soiled portion of the adhesive tape is separated from the adhesive tape, and allow the soiled portion of the adhesive tape to be easily separated from the adhesive tape without any damage of the adhesive tape even in a state where long hairs or vinyl segments adhere to the adhesive tape, and apparatus for and method of manufacturing the adhesive roll cleaner.

2. Background Art

In general, as shown in FIG. 6a, a roll cleaner for cleaning (or for an industrial use) is known as a roll type adhesive cleaner for catching up impurities 7, such as hairs, dusts or the like, dropping on the surfaces of carpets or beds using an adhesive tape 1 with an adhesive force. However, in case where the impurities 7, especially long hairs, adhere to the adhesive tape in a wound direction of the adhesive tape when a soiled portion of the adhesive tape is cut out to be replaced with a fresh adhesive tape, the adhesive tape may be easily torn in a longitudinal direction, and even though the adhesive tape is not torn, it is very difficult and inconvenient to find a cut portion thereof and replace the soiled portion of the adhesive tape with the fresh adhesive tape.

In the meantime, in order to address and solve the above problems, as shown in FIGS. 6b and 6c, an adhesive roll cleaner has been proposed which includes an adhesive tape wound around the outer periphery of a core tube in a spiral shape and uneven portions 8 or peelable projections 5 formed at both end portions thereof.

However, the adhesive roll cleaner also has several problems in that it is difficult to form the spiral shape and the uneven portions, and in that it is difficult to replace a soiled roll tape with a fresh roll tape since the peelable projection is formed only at a side of the roll cleaner.

### SUMMARY OF THE INVENTION

Accordingly, the present invention has been made to solve the above-mentioned problems occurring in the prior arts, and it is an object of the present invention to provide an adhesive roll cleaner, which includes an adhesive tape wound around the outer periphery of a core tube several times, the adhesive tape having an adhesive face continuously formed and having a sticky layer, a non-adhesive face formed on a back side of the adhesive face, a non-sticky release sheet of uniform thickness and width adhering to a start portion of the adhesive tape and having a uniform tensile strength in longitudinal and transverse directions, cut slits formed at a start portion of the release sheet to easily remove a soiled portion of the used adhesive tape, and an overlapped portion formed on the release sheet in such a way that ½ of the width of the release sheet is overlapped to thereby prevent the roll cleaner from being easily damaged by impurities, such as hairs or the like, and easily remove the soiled portion of the adhesive tape, and apparatus for and method of manufacturing the adhesive roll cleaner.

To accomplish the above object, according to the present invention, there is provided an adhesive roll cleaner comprising an adhesive tape wound around the outer periphery of a core tube, the adhesive tape including: an adhesive face having an adhesive applied thereto, the adhesive face being continuously formed in an outward direction of the core tube; a non-adhesive face formed on a back side of the adhesive face and surface-processed with silicon, the non-adhesive face not having an adhesive applied thereto; a non-sticky release sheet adhering to a start portion of the adhesive face and having uniform thickness and width; cut slits formed at a start portion of the adhesive face by a reciprocating motion of a breaker; and a peelable projection formed on the release sheet in such a way that ½ of the width of the release sheet is overlapped.

Furthermore, the release sheet mounted to prevent the adhesive tape from being easily torn out in a longitudinal and transverse direction when a soiled portion of the adhesive tape is removed is made of a material that Korean paper ingredient made with the paper mulberry is mixed with a general paper pulp at a predetermined ratio (20%) to obtain uniform tear strength in longitudinal and transverse directions, and contains a fluorescent paint and has the cut slits formed at the start portion thereto to allow an easy separation of the release sheet when the soiled portion of the adhesive tape is removed.

The adhesive roll cleaner according to the present invention can prevent that hairs adhere to the release sheet, prevent the adhesive tape from being damaged when the hairs wound around the circumference of the roll cleaner are removed, and easily peel off the soiled portion of the adhesive tape, since the non-sticky release sheet, which has the longitudinally and transversely uniform tear strength (tensile strength) and is coated with the fluorescent paint, adheres to the adhesive face of the adhesive tape.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1a is a perspective view of an adhesive roll cleaner according o the present invention;

FIG. 1b is a view showing a state where the adhesive roll cleaner is spread;

FIG. 2a is a development figure of the outermost portion of the adhesive roll cleaner;

FIG. 2b is a side view showing a rolled state of the adhesive roll cleaner;

FIG. 2c is a detailed view of an overlapped portion of a release sheet;

FIG. 3 is a plan view of an adhesive tape of the adhesive roll cleaner and sectional views of the adhesive tape taken along the lines of C-C and B-B;

FIG. 4 is a sectional view showing a state where the adhesive tape is wound around the outer periphery of a core tube, on which the adhesive roll cleaner is mounted;

FIG. 5 is a flow chart of a process to manufacture the adhesive roll cleaner;

FIGS. 6a to 6c are perspective views of conventional roll cleaners;

FIG. 6d is a view showing a completely assembled state of the conventional roll cleaners;

FIG. 7 is a perspective view of an apparatus for manufacturing the adhesive roll cleaner according to the present invention;

FIG. 8a is a plan view of a cutting knife of the apparatus;

FIG. 8b is a sectional view of the cutting knife;

FIG. 8c is a perspective view of the cutting knife; and

FIGS. 8d and 8e are partially enlarged views of essential parts of the cutting knife.

Table 1 shows a length calculation table by each adhesive tape and a development figure of the adhesive tape.

Table 2 shows a brake operation state and a roll tape conveyance speed.

### DETAILED DESCRIPTION OF THE PREFERRED EMBODIMENT

The above and other objects, features and advantages of the present invention will be more apparent from the following detailed description of the preferred embodiments of the invention in conjunction with the accompanying drawings. Terms and words used in this specification and claims should be interpreted as the meaning and concept conforming to the technical idea of the present invention based on the principle that the inventor can properly define the concept of the terms to explain the inventor's invention in the best way.

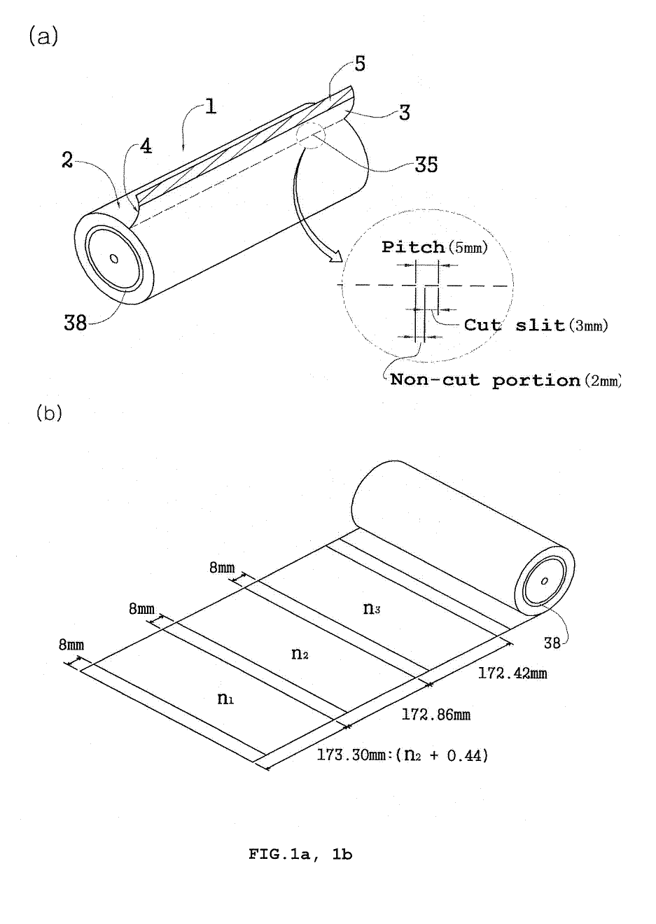

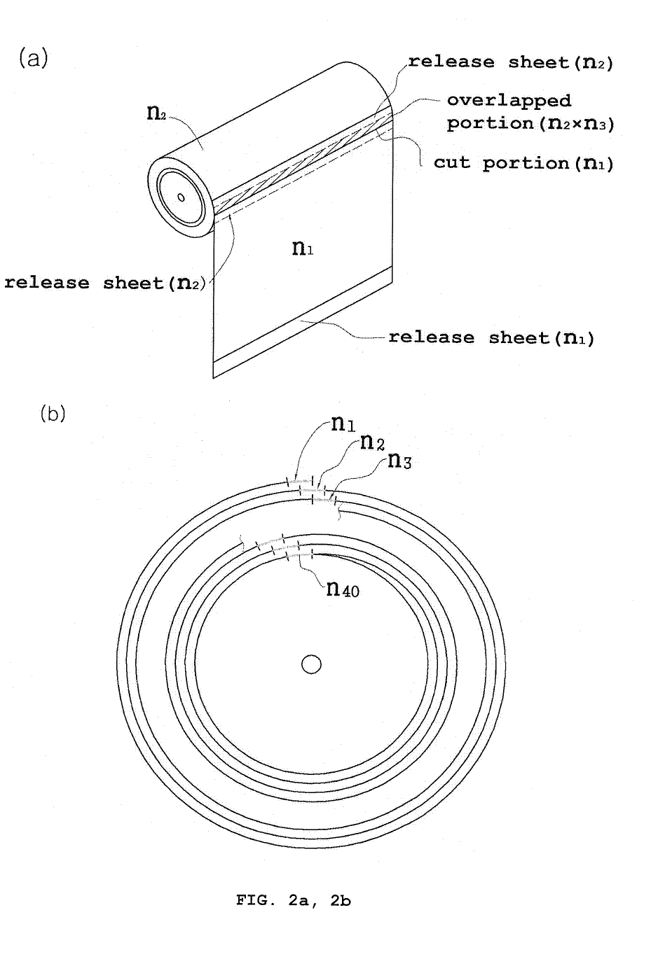

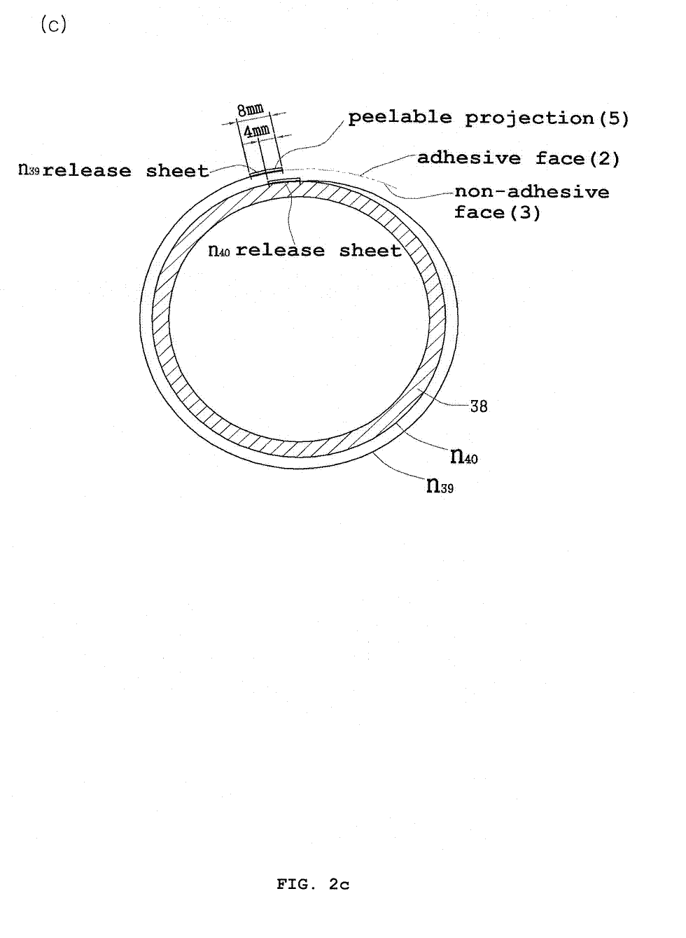

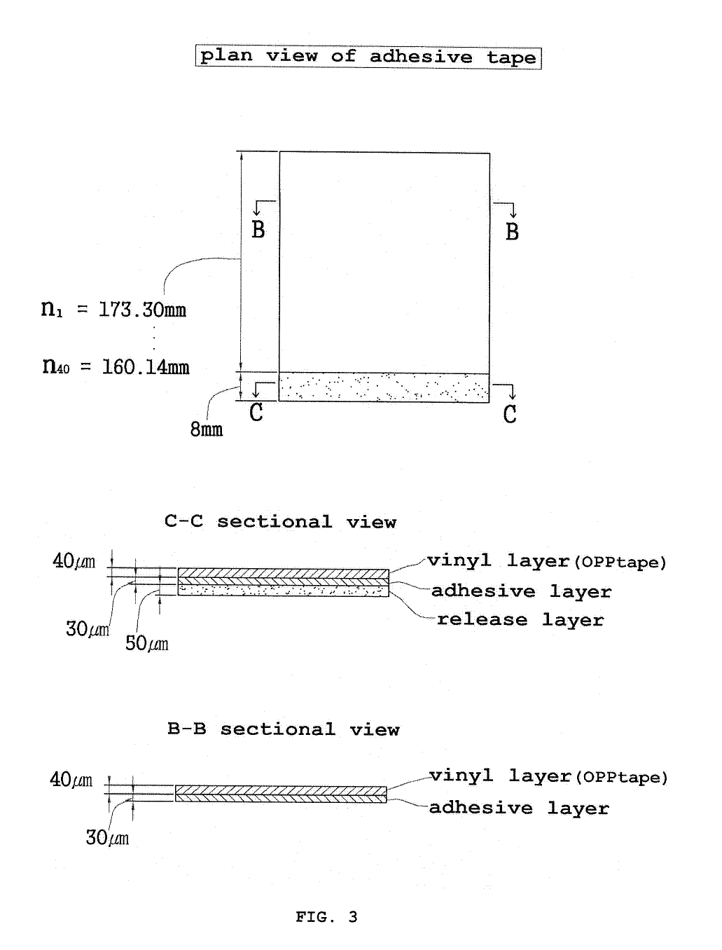

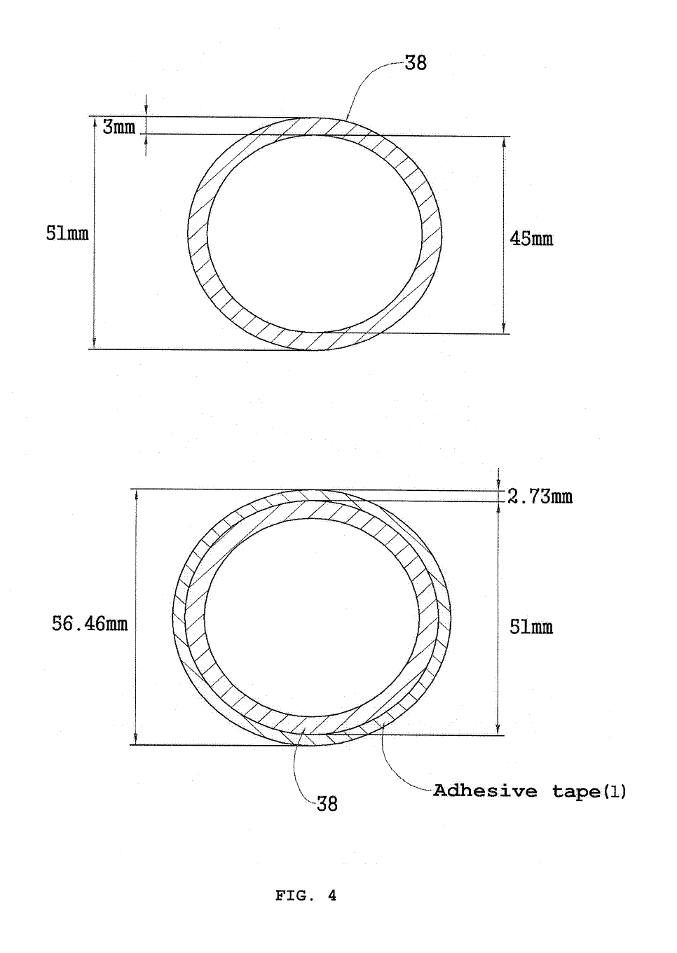

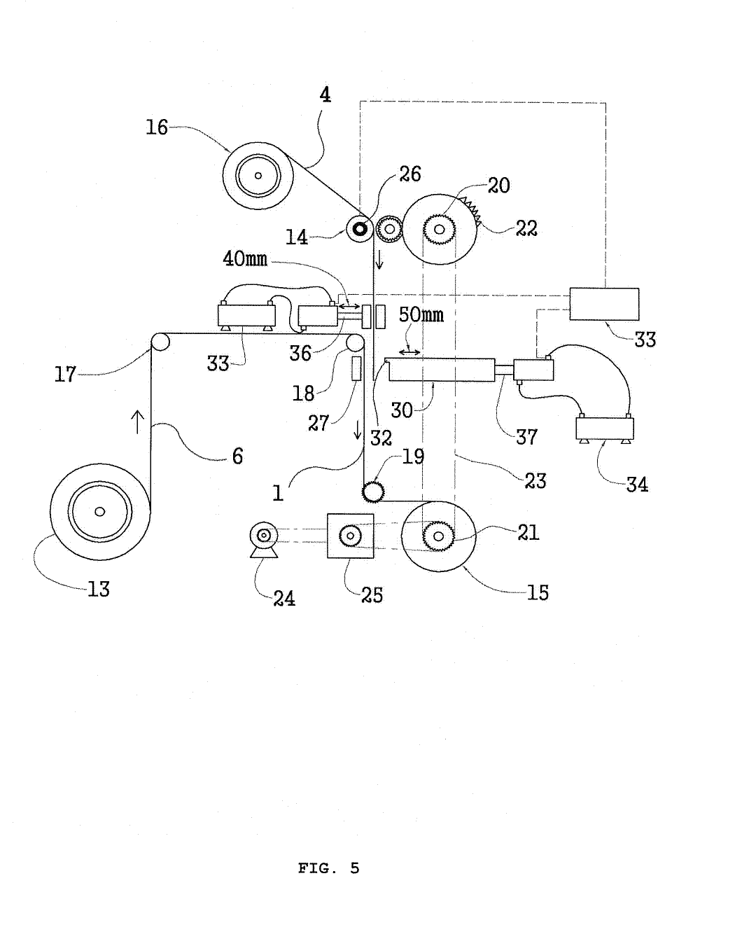

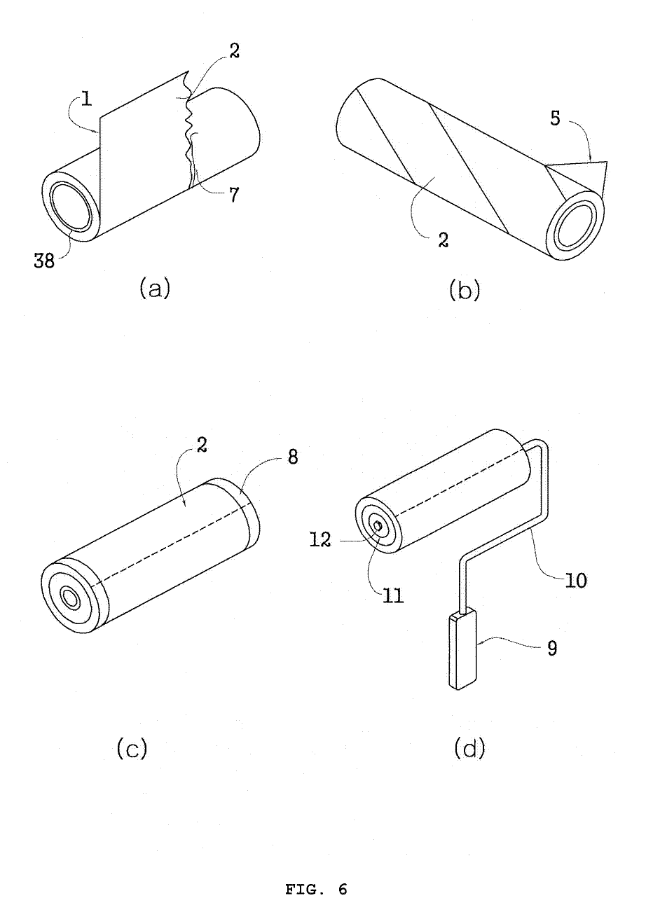

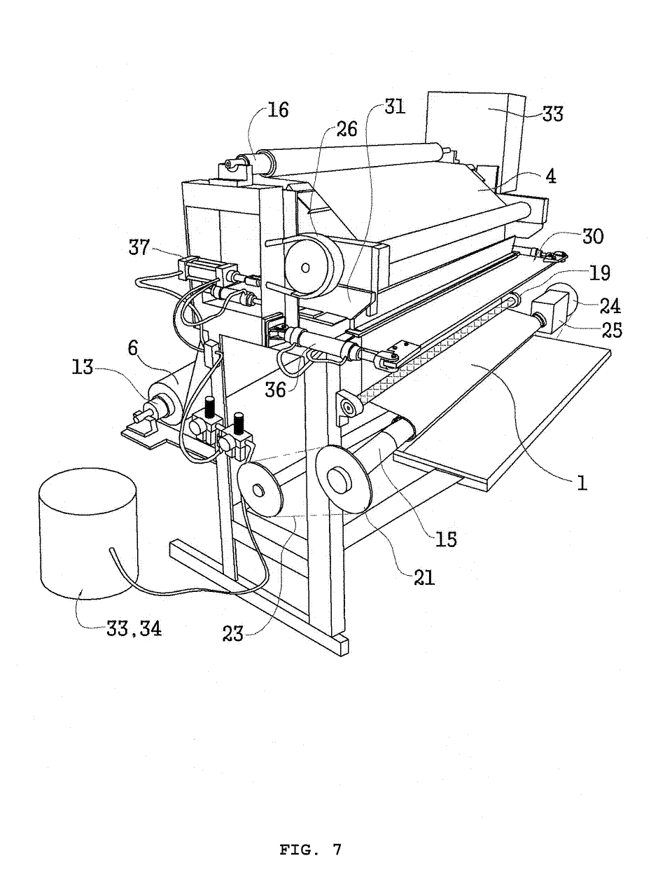

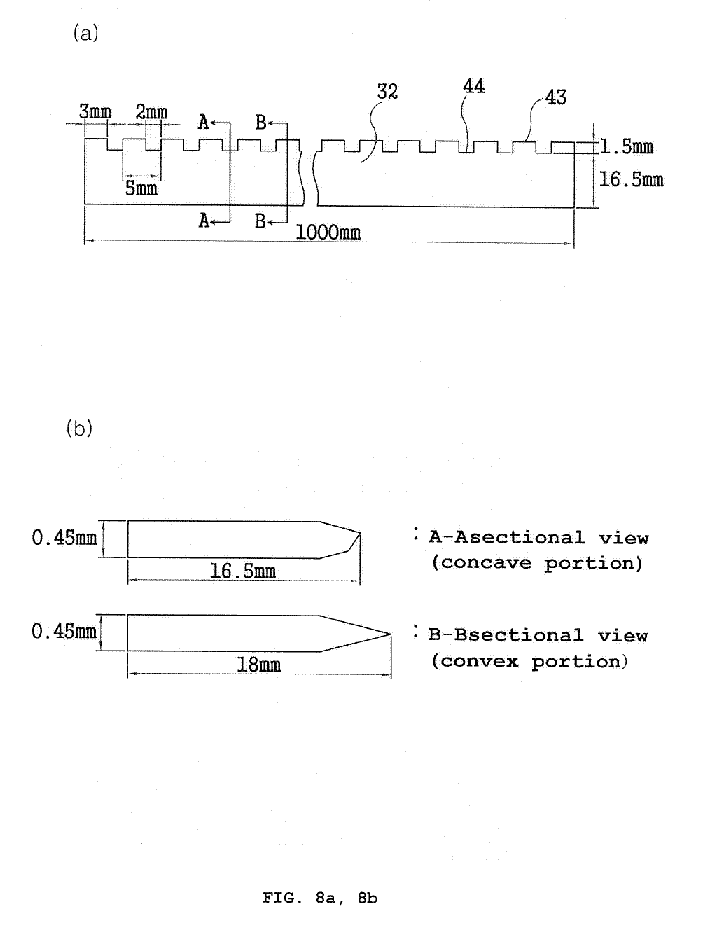

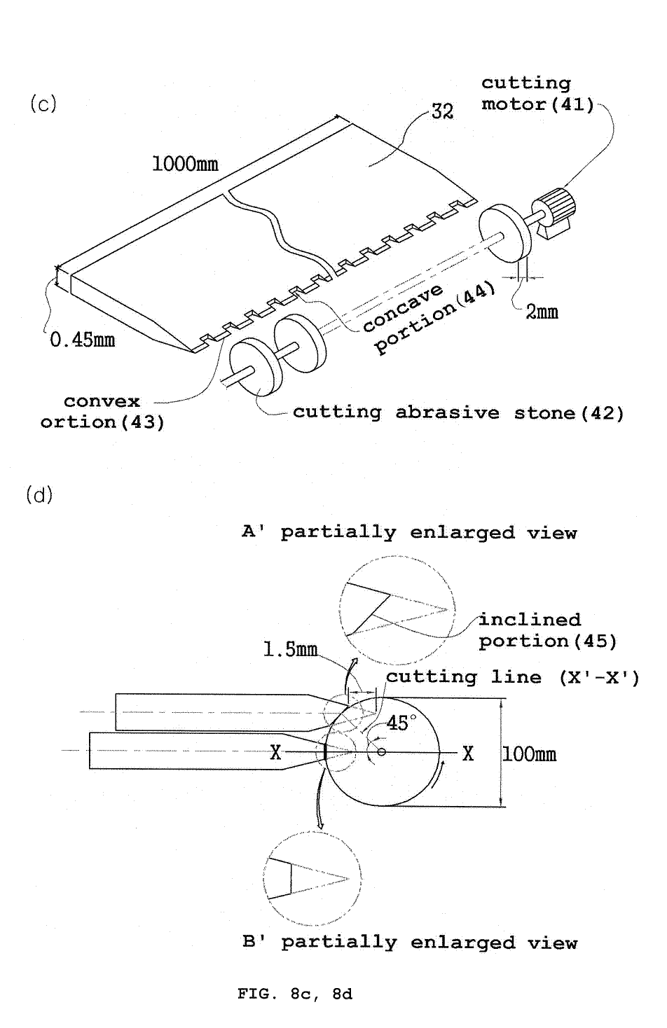

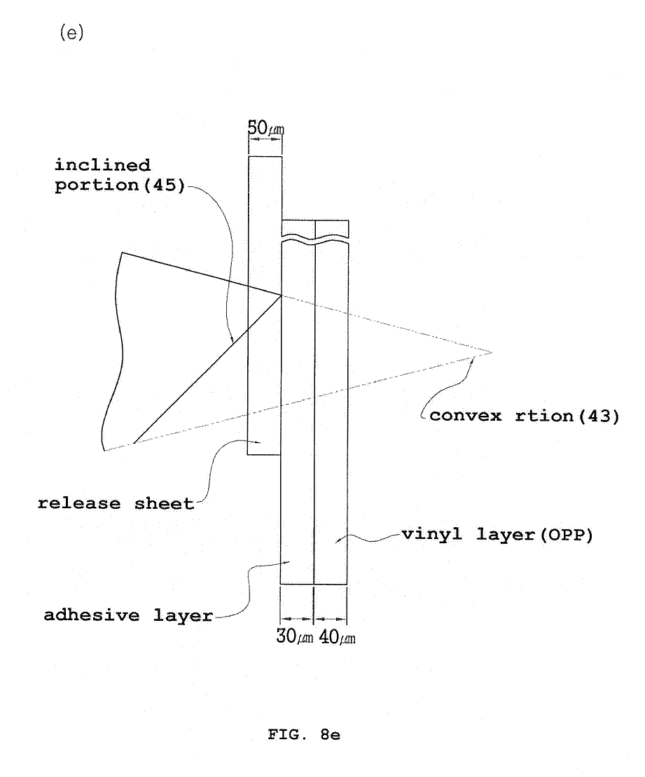

FIG. 1a is a perspective view of an adhesive roll cleaner to separate a soiled portion from an adhesive tape using a peelable projection, FIG. 1b is a view showing a state where the adhesive roll cleaner is spread, FIG. 2a is a development figure of the outermost portion of the adhesive roll cleaner, FIG. 2b is a side view showing a rolled state of the adhesive roll cleaner, FIG. 2c is a detailed view of an overlapped portion of a release sheet, FIG. 3 is a plan view of the adhesive tape of the adhesive roll cleaner and sectional views of the adhesive tape taken along the lines of C-C and B-B, FIG. 4 is a sectional view showing a state where the adhesive tape is wound around the outer periphery of a core tube, on which the adhesive roll cleaner is mounted, FIG. 5 is a flow chart of a process to manufacture the adhesive roll cleaner by adhering a release sheet to a packing tape (oriented polypropylene(OPP) sheet), FIGS. 6a to 6c are perspective views of conventional roll cleaners, FIG. 6d is a view showing a completely assembled state of the conventional roll cleaners, FIG. 7 is a perspective view of an apparatus for manufacturing the adhesive roll cleaner according to the present invention, FIG. 8a is a plan view of a cutting knife of the apparatus, FIG. 8b is a sectional view of the cutting knife, FIG. 8c is a perspective view of the cutting knife, and FIGS. 8d and 8e are partially enlarged views of essential parts of the cutting knife.

As shown in FIGS. 1a and 1b and 2a to 2c, the adhesive roll cleaner according to the present invention includes: an adhesive tape 1, the adhesive tape 1 having an adhesive face 2 continuously formed and an adhesive applied thereto to provide an adhesive force, a non-adhesive face 3 formed on a back side of the adhesive face 2 and not having the adhesive applied thereto, a non-sticky release sheet 4 of uniform thickness and width adhering to a start portion of the adhesive tape 1 in such a way as to be provided over the whole width (in a transverse direction) of the adhesive face 2, cut slits 35 formed at a starting portion of the release sheet 4 to allow a soiled portion of the adhesive tape to be easily cut out from the roll cleaner after use; and a peelable projection 5 formed on the released sheet 4 in such a way that ½ of the width of the release sheet 4 is overlapped with ½ of the width of another release sheet 4. The non-adhesive face 3 is surface-processed with silicon so that the non-adhesive face 3 can be easily separated from the adhesive face 2 when the soiled portion is removed from the adhesive tape 1 to obtain a fresh adhesive tape.

Accordingly, the peelable projection 5 is constructed in such a way that ½ of the non-sticky release sheet 4 is in contact with but separated from the backside of the adhesive tape, where the adhesive is not applied, and so, the soiled portion of the used adhesive tape can be conveniently separated from the non-used adhesive tape.

Furthermore, the release sheet 4 adapted to prevent that the adhesive tape is torn by impurities, such as hairs, and rapidly and easily separate the soiled portion from the adhesive tape is manufactured through the steps of adding a colored fluorescent paint and mixing Korean paper material of a predetermined ratio with a general paper material (pulp) in order to maintain a longitudinally and transversely uniform tensile strength, wherein the ratio of the added Korean paper material is within a range of 15% to 25% according to use purposes and scales of the used adhesive roll, and the thickness of the released sheet is 50 μm and a weight per unit area of the release sheet is 70 g/m².

If the ratio of the Korean paper material is higher than the above-mentioned ratio, a tear strength can be maintained high but it is inconvenient to manufacture and use for lack of pliability. On the other hand, if the ratio of the Korean paper material is lower than the above-mentioned ratio, impurities (especially, hairs) adhere to the adhesive tape in a longitudinal direction due to lowering of the tear strength, and so, the adhesive tape is torn when the impurities are removed. Accordingly, it is preferable that Korean paper is contained in an amount of 15% by weight to 25% by weight, particularly, 20% based on the total weight of the release sheet including the Korean paper.

Moreover, it is preferable that the width (longitudinal direction) of the release sheet 4, to which the fluorescent paint is added, ranges from 8 mm to 10 mm. In this instance, in case where the release sheet 4 of 8 mm in width is wound around the outer periphery of a core tube generally used and the peelable projection 5 is formed on ½ of the whole width of the release sheet 4, since the completed adhesive roll (40 times rolling) can keep not an oval form but a round form, the adhesive roll can perform a rolling motion smoothly to thereby easily catch up the impurities.

In order to prevent cutting-out of a packing tape 6 when the adhesive roll cleaner is manufactured and to easily separate the soiled portion from the adhesive tape to obtain the fresh adhesive tape, as shown in FIG. 1a, the cut slits 35 are formed on the release sheet 4 at intervals of 5 mm, and a width of the cut slit 35 is 3 mm.

If the width of the cut slit 35 exceeds 3 mm, the release sheet 4 and the packing tape 6 are simultaneously cut out when the cut slits 35 are formed, on the contrary, if the width of the cut slit 35 is less than 3 mm, it may cause a hindrance in smoothly cutting the release sheet 4 and it is difficult to easily separate the soiled portion from the adhesive tape 1 to obtain the fresh adhesive tape.

To solve the above problems, as shown in FIGS. 8a to 8c, a cutting knife 32 having a front portion of a convexo-concave form to form the cut slits 35 on the release sheet 4 is 1.5 mm in height (h) and 5 mm in pitch (p), and convex portions 43 of the cutting knife 32 for forming the cut slits 35 has a width of 3 mm, and concave portions 44, which do not form the cut slits 35, has a width of 2 mm. A thickness of the cutting knife 32 is within a range of 0.45 mm to 0.75 mm in consideration of a price for cutting (forming the convexo-concave form) and intensity of the adhesive tape.

In the meantime, in order to completely adhere the release sheet 4 to the packing tape 6 and reduce a noise generated during cutting, a buffering rubber plate 14 is mounted beneath a cutter 31. The buffering rubber plate 14 has the same width (8 mm to 10 mm) and length as the release sheet 4 to be cut.

In addition, as shown in FIG. 3, the adhesive tape 1 includes a vinyl layer of 40 μm, which is made of the same material (OPP: oriented polypropylene) as the packing tape 6, and an adhesive layer of 30 μm formed in such a way that the adhesive is applied to a surface of the vinyl layer. In this instance, in order to prevent a damage of the adhesive tape and inconvenience in removal of the impurities, it is preferable that the packing tape 6, on which the adhesive is applied, has an adhesive force of 700 g/25 mm and the tensile strength of 5 kg/10 mm.

As shown in FIG. 4, the core tube 38 is made with a cylindrical paper material, which has an inner diameter of 45 mm and a thickness of 3 mm.

Moreover, as shown in FIGS. 5 and 7, an apparatus for manufacturing the adhesive roll cleaner includes: an adhesive tape roller 15 for winding the adhesive tape 1, to which the release sheet 4 adheres, around the core tube; a release sheet conveying roller 16 for conveying the release sheet 4; a driving motor 24 for driving the adhesive tape roller 15 and the release sheet conveying roller 16; a decelerator 25 for decelerating rotational frequency of the driving motor 24; a driving chain 23 and sprockets 20 and 21 connected to the decelerator 25 for transmission of a driving force; a breaker 30 adapted to form the cut slits 35 on the release sheet 4 and the packing tape 6 transferred by the driving force of the driving chain 23 and the sprockets 20 and 21 and adhere the release sheet 4 to the packing tape 6, the breaker 30 having the cutting knife 32 mounted thereon; cutting abrasive stones 42 for forming the convex portions 43 and the concave portions 44 on a blade portion of the cutting knife 32, the concave portion 44 having an inclined portion 45; the cutter 31 adapted to select and cut only the release sheet 4 adhering to the packing tape 6 by the breaker 30; actuators 36 and 37 for reciprocating the breaker 30 and the cutter 31; compressors 33 and 34 for supplying air pressure to the actuators 36 and 37; a buffering member 27 made of a rubber material for absorbing a shock generated when the breaker 30 and the cutter 31 are actuated; a brake actuator 26 mounted on a shaft of an idle roller 16 in order to prevent a movement of the release sheet 4 due to a vibration and a shake; support rollers 17 and 18 adapted to support the non-adhesive face 3 for promoting a smooth conveyance of the release sheet 4 and the packing tape 6; an embossed roller 19 mounted on the adhesive face 2, on which the adhesive is applied; an intermittent transmission gear 22 for adjusting lengths of the packing tape 6 and the release sheet 4 conveyed by the rollers 17, 18 and 19 at a proper ratio; and a controller 33 for controlling the operations of the breaker 30 and the cutter 31 and the operation of the brake actuator 26 which prevents the movement of the release sheet 4.

In the meantime, as shown in FIGS. 8c and 8d, the cutting abrasive stone 42 mounted on the blade portion of the cutting knife 32 of the breaker 30 for forming the convex portions 43 and the concave portions 44 has a thickness of 2 mm and a diameter of 10 mm, and is made of a WA (white aluminum oxide)-based material, which has a surface roughness of 35-s, in consideration of vibration and cutting efficiency during cutting. Furthermore, the cutting knife 32 is 5 mm in pitch, and the convex portions 43 and the concave portions 44 are respectively 3 mm and 2 mm in width and 1.5 mm in height (h).

In order to smoothly separate the release sheet from the packing tape and easily remove the soiled portion of the adhesive tape to obtain the fresh adhesive tape, as shown in FIG. 8b, the inclined portion 45 is formed on the concave portion 44 of the cutting knife 32.

For this, as shown in FIG. 8d, a central line (X-X) of the cutting abrasive stone meets with a cutting line (X′-X′) of the cutting knife 32 at an angle of about 45 degrees, so that also the concave portion 44 can have a cutting function.

That is, as shown in FIG. 8e, since the inclined portion 45 having the cutting function is formed on the concave portion 44 of the cutting knife 32, out of the cutting knife 32 having the pitch of 5 mm, the convex portions 43 having the pitch of 3 mm penetrate the packing tape to form the cut slits 35 and the concave portions 44 having the pitch of 2 mm selectively cut only the release sheet 4.

It is preferable that the cutting knife 32 is made of a carbon steel material having a tensile strength of 63 kg/mm² or more.

Accordingly, when the adhesive tape 1 is wound around the outer periphery of the core tube, the adhesive roll cleaner can be manufactured in a state where the release sheet 4 can be easily cut but the vinyl layer, on which the adhesive is applied, is not cut.

Moreover, a method of manufacturing the adhesive roll cleaner includes the steps of: (s1) conveying the release sheet 4 and the packing tape 6 through the cooperative operation of the release sheet conveying roller 16 and the adhesive tape roller 15; (s2) adhering the release sheet 4 to the packing tape 6 in such a way that the breaker 30, on which the cutting knife 32 having the convex portions 43 and the concave portions 44 formed by the cutting abrasive stones 42 is mounted, and the cutter 31 for cutting the release sheet 4 are actuated and perform a reciprocating motion when the release sheet 4 is lowered by 8 mm to 1 mm, and in this instance, reciprocating motion distances of the breaker 30 and the cutter 31 are 50 mm and 40 mm, respectively, which are stroke distances for easily separating the release sheet from the adhesive tape, in consideration of the tensile strengths of the packing tape and the release sheet; (s3) operating the brake actuator 26 mounted on the shaft of the idle roller 16 in order to prevent the movement of the release sheet 4 lowering before and after the release sheet 4 is cut; (s4) cutting the adhesive tape 1 wound around the adhesive tape roller 15 into a proper size (ranging from 125 mm to 250 mm) ; and (s5) fixing right and left supporters (11) to a supporting body (10), on which a hand-grip (9) is fixed, via a fixing bolt (12) to allow a rotational motion of a completed roll, and adhering a finishing packing material to the adhesive tape (1).

Furthermore, in order to smoothly supply the release sheet and form a correct overlapped portion (½ of the width of the release sheet), as indicated in Table 1, the finally used adhesive tape (n40) has the same length (160.14 mm) as the outer diameter of the core tube 6. If the adhesive tape (n39) wound after the above is 4 mm shorter than the outer diameter (in case where the width of the release sheet is 8 mm) in order to keep the ½ overlapping with another release sheet of the adhesive tape separated just before, the length of the adhesive tape (n39) becomes 156.58 mm due to an increase of the thickness (0.44 mm:70 μm*2/3.14—an increase of the thickness of the release sheet is not calculated) of the finally used adhesive tape (n40).

That is, n40 (length of first wound adhesive tape)=160.14 mm (51*3.14: including the release sheet of 8 mm)

n39=156.58 mm (n40−4 mm+0.44 mm)

n38=157.02 mm (n39+0.44 mm)

•

•

•

n2=172.86 mm (n2+0.44 mm)

n1 (first used adhesive tape)=173.30 mm {(n2+0.44 mm) or [(51 mm+2.73mm*2)*π−4 mm]}, wherein 0.44 mm is a correction value for length extension according to the increase of the thickness (once rolling), 51 mm is the outer diameter of the core tube, 4 mm is the width of the overlapped portion, and 2.73 mm is the thickness of the adhesive tape ranging from n1 to n40. [The number of the entire rolling times ranging from n1 to n40 is 39 since the roll does not rotate by 1/40 rotation every time. So, the increased thickness is 39*(70 μm)=2730 μm, wherein 70 μm is a value that a thickness of the applied adhesive, 30 μm, is added to the thickness of the packing tape, namely, the thickness of the vinyl tape, 40 μm.]

Accordingly, the peelable projection 5 of a uniform thickness can be formed on the adhesive tape by the operation of the adhesive tape roller 15, which rotates at a uniform speed without regard to the increase of the thickness.

However, besides the above method of adhering the release sheet to the packing tape, other various methods can be applied according to standards and manufacturing conditions of the roll cleaner.

For instance, there is a method to measure the length of the lowering release sheet 4 using a sensor and cut the release sheet 4 by separately controlling the rollers according to a change (increase) in length of the release sheet 4 after linking the breaker 30 with a timer of the cutter 31.

Moreover, as indicated in Table 2, it is preferable to form brake actuating intervals of 3 sec and 4 sec in order to prevent the movement of the release sheet supplied before and after the tape cutting step to adhere the release sheet 4 to the packing tape 6. The finally used adhesive tape (n40) may be a double-side adhesive tape to promote a cleaning work. If a conveyance speed of the first rolled adhesive tape (n40) is 12 mm/sec, as described above, a conveyance speed of the finally used adhesive tape (n1) becomes 13 mm/sec (the speed is increased about 8.5% according to the increase in diameter) due to the thickness (2.73 mm) of the rolled adhesive tape, so that the overlapped portion (peelable projection 5) of the fixed thickness can be obtained since the length of the adhesive tape is increased due to the increase of the number of rolling times (increase of the diameter).

The finished adhesive roll cleaner can prevent inconvenience (stickiness) in keeping and use since the finishing packing material (not shown) is wound on the adhesive tape of the outermost layer (n1).

Meanwhile, it is preferable that the finishing packing material is made of a paper-based or vinyl-based material and a face being in contact with the adhesive face 2 is processed with silicon for a smooth separation.

TABLE 1
Length Calculation Table

| | | Re- | | |
|---|---|---|---|---|
| | Length | lease | Overlapped | |
| Div. | (mm) | sheet | portion | Remark |
| n₁ | 173.30 | 8 | 4 | Double-sided adhesive tape: |
| | | | | (51 mm + 2.73 mm × 2) × n-4 mm |
| n₂ | 172.86 | 8 | 4 | One-sided adhesive tape: |
| | | | | n₃ + 0.44 mm |
| n₃ | 172.42 | 8 | 4 | One-sided adhesive tape: |
| | | | | n₄ + 0.44 mm |
| . | . | . | . | |
| . | . | . | . | |
| . | . | . | . | |
| n₃₈ | 156.14 | 8 | 4 | One-sided adhesive tape: |
| | | | | n₃₉ + 0.44 mm |
| n₃₉ | 156.58 | 8 | 4 | One-sided adhesive tape: |
| | | | | n₄₀ − 0.44 mm + 0.44 mm |
| n₄₀ | 160.14 | 8 | 4 | One-sided adhesive tape: |
| | | | | 51 mm × n |
| Sum | ≈6700 | | | |

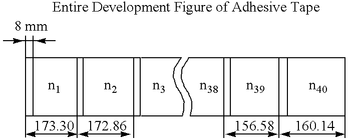

As described above, according to the adhesive roll cleaner and apparatus for and method of manufacturing the same of the present invention, since the non-sticky release sheet, which has the longitudinally and transversely uniform tear strength, adheres to the adhesive face, on which the adhesive is applied, so that the soiled portion of the adhesive tape can be easily separated from the roll cleaner, whereby the impurities, such as long hairs, do not adhere to the release sheet having the non-sticky circumference even though the impurities adhere to the adhesive tape, and even the adhered hairs longer than the adhesive tape can be easily removed without any damage of the adhesive tape.

Furthermore, since ½ of the release sheet of the used adhesive tape is overlapped with ½ of another release sheet of the fresh adhesive tape and the overlapped portion of the release sheet, on which fluorescent paint is coated on the entire longitudinal of the adhesive tape, is exposed to the outside, a user can easily find the peelable projection even under a dark illumination and rapidly and easily separate the peelable projection.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. An adhesive roll cleaner, which includes a cylindrical core tube (38) and an one-sided adhesive tape (1) wound around the outer periphery of the core tube 38 several times, wherein the adhesive tape (1) comprises: an adhesive face (2) with stickiness having an adhesive applied thereto and continuously formed in an outward direction of the core tube (38); a non-adhesive face (3) formed on a back side of the adhesive face (2), the non-adhesive face (3) being surface-processed with silicon and not having the adhesive applied thereto; a non-sticky release sheet (4) mounted at a start portion of the adhesive face (2) in such a way as to be provided over the whole width (in a transverse direction) of the adhesive face (2); and a peelable projection (5) formed on the release sheet (4) in such a way that ½ of a width of the release sheet (4) is overlapped.

2. The adhesive roll cleaner according to claim 1, wherein the release sheet (4) has a width (longitudinal direction) ranging from 8 mm to 10 mm and is made of a material comprising 80% of paper pulp and 20% of Korean paper as main ingredients

3. The adhesive roll cleaner according to claim 2, wherein the release sheet (4) has a thickness of 50 μm and a weight per unit area of 70 g/m².

4. The adhesive roll cleaner according to claim 2, wherein the release sheet (4) contains a colored fluorescent material.

5. An apparatus for manufacturing an adhesive roll cleaner comprising:
an adhesive tape roller (15) for winding an adhesive tape (1), to which a release sheet (4) adheres, around the outer periphery of a core tube;
a release sheet conveying roller (16) for conveying the release sheet (4);
a driving motor (24) for driving the adhesive tape roller (15) and the release sheet conveying roller (16);
a decelerator (25) for decelerating rotational frequency of the driving motor (24);
a driving chain (23) and sprockets (20; 21) connected to the decelerator (25) for transmission of a driving force;
a breaker (30) adapted to form cut slits (35) on the release sheet (4) and a packing tape (6) transferred by the driving force of the driving chain (23) and the sprockets (20; 21) and adhere the release sheet (4) to the packing tape (6), the breaker (30) having a cutting knife (32) mounted thereon;
cutting abrasive stones (42) having convex portions (43) and concave portions (44) formed on a blade portion of the cutting knife (32), the concave portion (44) having an inclined portion (45);
a cutter (31) adapted to select and cut only the release sheet (4) adhering to the packing tape (6) by the breaker (30);
actuators (36; 37) for reciprocating the breaker (30) and the cutter (31);
compressors (33; 34) for supplying air pressure to the actuators (36; 37);
a buffering member (27) made of a rubber material for absorbing a shock generated when the breaker (30) and the cutter (31) are actuated;
a brake actuator (26) mounted on a shaft of an idle roller (16) in order to prevent a movement of the release sheet (4) due to a vibration and a shake;
support rollers (17; 18) adapted to support a non-adhesive face (3) of the adhesive tape for promoting a smooth conveyance of the release sheet (4) and the packing tape (6);
an embossed roller (19) mounted on the adhesive face (2) having an adhesive applied thereto;
an intermittent transmission gear (22) for adjusting lengths of the packing tape (6) and the release sheet (4) conveyed by the rollers (17, 18 and 19) at a proper ratio; and
a controller (33) for controlling the operations of the breaker (30) and the cutter (31) and the operation of the brake actuator (26) which prevents the movement of the release sheet (4).

6. The apparatus for manufacturing an adhesive roll cleaner according to claim 5, wherein the blade portion of the cutting knife (32) is in a convexo-concave form in such a way that the convex portion (43) has a width of 3 mm and the concave portion (44) has a width of 2 mm, wherein the convex portion has a height (h) of 1.5 mm, and wherein the cutting knife (32) has a thickness ranging from 0.45 mm to 0.75 mm.

7. The apparatus for manufacturing an adhesive roll cleaner according to claim 5, wherein a central line (X-X) of the cutting abrasive stone (42) meets with a cutting line (X′-X′) of the cutting knife (32) at an angle of about 45 degrees.

8. The apparatus for manufacturing an adhesive roll cleaner according to claim 7, wherein the cutting abrasive stone (42) has a diameter of 100 mm, a thickness of 2 mm, and a surface roughness of 35-s.

9. A method of manufacturing an adhesive roll cleaner, comprising the steps of:
a step (s1) of conveying a release sheet (4) and a packing tape (6) through the cooperative operation of a release sheet conveying roller (16) and an adhesive tape roller (15);
a step (s2) of forming cut slits (35) on the release sheet (4) by a breaker (30) and selectively cutting only the release sheet (4) by a cutter (31) when the release sheet (4) is lowered by 8 mm to 10 mm;
a step (s3) of operating a brake actuator (26) mounted on a shaft of an idle roller (16) in order to prevent a movement of the release sheet (4) lowering before and after the release sheet (4) is cut;
a step (s4) of cutting an adhesive tape (1) wound around the adhesive tape roller (15) into a proper size (ranging from 125 mm to 250 mm); and
a step (s5) of fixing right and left supporters (11) to a supporting body (10), on which a hand-grip (9) is fixed, via a fixing bolt (12) to allow a rotational motion of a completed roll, and adhering a finishing packing material to the adhesive tape (1).

10. The method of manufacturing the adhesive roll cleaner according to claim 9, wherein reciprocating motion distances of the breaker (30) and the cutter (31) are 50 mm and 40 mm, respectively.
